(19) United States
(12) Patent Application Publication
(10) Pub. No.: US 2016/0239073 A1
(43) Pub. Date: Aug. 18, 2016

(54) AN ELECTRONIC DEVICE WITH POSITIONING FUNCTION AND A POWER SAVING METHOD THEREOF

(71) Applicants: Xing DENG, Chengdu, Sichuan (CN); Ming-Ta WU, Taoyuan City, Taiwan (CN); Yong LIU, Chengdu, Sichuan (CN); Lindun TANG, Chengdu, Sichuan (CN); Xue WANG, Chengdu, Sichuan (CN)

(72) Inventors: Xing DENG, Chengdu (CN); Ming-Ta WU, Taoyuan City, Taoyuan County (TW); Yong LIU, Chengdu (CN); Lindun TANG, Chengdu (CN); Xue WANG, Chengdu (CN)

(21) Appl. No.: 15/030,035

(22) PCT Filed: Sep. 18, 2015
(86) PCT No.: PCT/CN2015/089991

§ 371 Date: Apr. 15, 2016

(30) Foreign Application Priority Data
Sep. 18, 2014 (CN) 201410476772.2
Aug. 31, 2015 (CN) 201510548752.6

(51) Int. Cl. G06F 1/32; H04W 4/02

(52) U.S. Cl. CPC G06F 1/3234; H04W 4/02

(57) ABSTRACT

An embodiment of the invention provides a power saving method for an electronic device with positioning function. The method includes steps of acquiring a positioning cycle of the electronic device; estimating power consumptions corresponding to at least two operating modes during the positioning cycle; and choosing an operating mode with minimum power consumption from the at least two operating modes to be the operating mode of the electronic device during the positioning cycle.

### CROSS REFERENCE TO RELATED APPLICATIONS

This application is a National Phase of PCT/CN2015/089991, filed on Sep. 18, 2015, which claims priority of China Patent Application No. 201410476772.2, filed on Sep. 18, 2014, the entirety of which is incorporated by reference herein. The application further claims priority of China Patent Application No. 201510548752.6, filed on Aug. 31, 2015, the entirety of which is incorporated by reference herein.

### TECHNICAL FIELD

The present invention relates to a mobile communication technology, and more particularly to an electronic device with positioning function and a power-saving method thereof.

### BACKGROUND

Nowadays, with the development of technology, wearable devices or IOT (internet of things) devices are becoming more and more popular. Typically, the most notable feature of wearable devices or IOT devices, such as smart watches, smart bracelet, intelligent tracker, is light-weight and small size. The devices illustrated above generally depend on external devices, such as global positioning systems, wireless LANs, modems, sensors (GPS/WIFI/Modem/Sensor), to enable trajectory-descripted function or navigation functions of devices. For the current electronic devices on the market, GPS function of devices requires high quality satellite signals and consumes huge power. The power consumption of WIFI/Modem in a standby mode is not small. The total power consumption of these functions is great and limits the life time of the battery embedded in the electronic device. Therefore, it is desirable to solve the power consumption issue and increases battery life of the electronic device. Specially, the power consumption when the wearable devices or IOT devices are turned on or operated is great and will affect the usage time of the electronic devices. It becomes a core issue to achieve the lowest possible power consumption for efficient intelligent peripheral control for the electronic devices.

### SUMMARY

An embodiment of the invention provides a power-saving method to solve an issue of large power consumption of an electronic device with positioning function.

An embodiment of the invention provides a power saving method for an electronic device with positioning function. The method comprises steps of acquiring a positioning cycle of the electronic device; estimating power consumptions corresponding to at least two operating modes during the positioning cycle; and choosing an operating mode with minimum power consumption from the at least two operating modes to be the operating mode of the electronic device during the positioning cycle.

In one aspect of the invention, the method further comprises a step of performing a Global Navigation Satellite System positioning function, by the electronic device, under the operating mode with minimum power consumption.

In one aspect of the invention, the method further comprises a step of determining whether the electronic device needs to activate the positioning function.

In one aspect of the invention, the at least two operating mode comprises a first operating mode and a second operating mode, the first operating mode is a turn-off operating mode, the second operating mode is a sleeping operating mode, the positioning cycle of the turn-off operating mode comprises an activation time and a normal operation time, and the positioning cycle of the sleeping operating mode comprises a sleeping time and the normal operation time.

In one aspect of the invention, the power consumptions corresponding to at least two operating modes are estimated according to equations listed as following:

W1=Cstartup×Tstartup+Cworking×Tworking,

wherein W1 is a first power consumption of the electronic device corresponding to the turn-off operating mode during the positioning cycle, Cstartup is an average current that the electronic device switches from a turn-off state to a turn-in state, Tstartup is the activation time that the electronic device switches from the turn-off state to the turn-in state, Cworking is an average current when the electronic device operates during the normal operation time, and Tworking is the normal operation time; and

W2=Csleep×(T−Tworking)+Cworking×Tworking, wherein

W2 is a second power consumption of the electronic device corresponding to the sleeping operating mode during the positioning cycle, Csleep is an average current that the electronic device has in a sleeping state, Cworking is an average current when the electronic device operates during the normal operation time, and Tworking is the normal operation time.

In one aspect of the invention, the at least two operating modes further comprises a third operating mode, and the step of estimating power consumptions corresponding to the at least two operating modes during the positioning cycle further comprises a step of estimating the first power consumption of the electronic device corresponding to the turn-off operating mode during the positioning cycle, the second power consumption of the electronic device corresponding to the sleeping operating mode during the positioning cycle, and a third power consumption of the electronic device corresponding to the third operating mode during the positioning cycle.

In one aspect of the invention, the positioning cycle of the third operating mode comprises an non-working time and the normal operation time, the third power consumption corresponding to the third operating mode is estimated by the equation as following:

W3=Wn+Cworking×Tworking,

wherein W3 is the third power consumption of the electronic device corresponding to the third operating mode during the positioning cycle, Wn is a power consumption of the electronic device during the non-working time, Cworking is an average current when the electronic device operates during the normal operation time, and Tworking is the normal operation time.

In another embodiment of the invention, an electronic device with a positioning function is provided. The electronic device comprises a cycle acquisition module, a power consumption estimation module and a mode determination module. The cycle acquisition module acquires a positioning cycle of the electronic device. The power consumption estimation module estimates power consumptions corresponding to at least two operating modes during the positioning cycle. The mode determination module chooses an operating mode with minimum power consumption from the at least two operating modes to be the operating mode of the electronic device during the positioning cycle.

In one aspect of the invention, the electronic device further comprises a positioning module to perform a Global Navigation Satellite System positioning function, by the electronic device, under the operating mode with minimum power consumption.

In one aspect of the invention, the at least two operating mode comprises a first operating mode and a second operating mode, the first operating mode is a turn-off operating mode, the second operating mode is a sleeping operating mode, the positioning cycle of the turn-off operating mode comprises an activation time and a normal operation time, and the positioning cycle of the sleeping operating mode comprises a sleeping time and the normal operation time.

In one aspect of the invention, the power consumption estimation module further comprises a first power consumption estimation module and a second power consumption estimation module to estimate a first power consumption of the electronic device corresponding to the turn-off operating mode during the positioning cycle and a second power consumption of the electronic device corresponding to the sleeping operating mode during the positioning cycle respectively. The first power consumption is estimated by equation:

W1=Cstartup×Tstartup+Cworking×Tworking,

wherein W1 is the first power consumption of the electronic device corresponding to the turn-off operating mode during the positioning cycle, Cstartup is an average current that the electronic device switches from a turn-off state to a turn-in state, Tstartup is the activation time that the electronic device switches from the turn-off state to the turn-in state, Cworking is an average current when the electronic device operates during the normal operation time, and Tworking is the normal operation time.

The second power consumption is estimated by equation:

W2=Csleep×(T−Tworking)+Cworking×Tworking, wherein

W2 is the second power consumption of the electronic device corresponding to the sleeping operating mode during the positioning cycle, Csleep is an average current that the electronic device has in a sleeping state, Cworking is an average current when the electronic device operates during the normal operation time, and Tworking is the normal operation time.

In one aspect of the invention, the at least two operating modes further comprises a third operating mode, and the power consumption estimation module estimate the first power consumption of the electronic device corresponding to the turn-off operating mode during the positioning cycle, the second power consumption of the electronic device corresponding to the sleeping operating mode during the positioning cycle respectively and a third power consumption of the electronic device corresponding to the third operating mode during the positioning cycle.

In one aspect of the invention, the power consumption estimation module further comprises a third power consumption estimation module to estimate the third power consumption of the electronic device corresponding to the third operating mode during the positioning cycle. The third power consumption is estimated by equation:

W3=Wn+Cworking×Tworking,

wherein W3 is the third power consumption of the electronic device corresponding to the third operating mode during the positioning cycle, Wn is a power consumption of the electronic device during the non-working time, Cworking is an average current when the electronic device operates during the normal operation time, and Tworking is the normal operation time.

One benefit of the invention is the electronic device can greatly reduce the power consumption during the positioning cycle, and effectively improve the battery life of the electronic device accordingly. The proposed electronic device first estimates power consumptions corresponding to at least two operating modes during the positioning cycle, and then the electronic device chooses an operating mode with minimum power consumption to be the operating mode of the electronic device during the positioning cycle. According to the operating mechanism, the benefit of the invention is implemented.

A detailed description is given in the following embodiments with reference to the accompanying drawings.

### BRIEF DESCRIPTION OF DRAWINGS

The present invention can be more fully understood by reading the subsequent detailed description and examples with references made to the accompanying drawings, wherein:

FIG. 1 is flowchart of a power-saving method for an electronic device with positioning function according to an embodiment of the invention.

FIG. 2 is a schematic diagram of a control mechanism according to an embodiment of the invention.

FIG. 3 is a schematic diagram of a control mechanism according to another embodiment of the invention.

FIGS. 4A and 4B show a flowchart of a power-saving method for an electronic device with positioning function according to another embodiment of the invention.

FIG. 5 is a schematic diagram of an electronic device with positioning function according to an embodiment of the invention.

FIG. 6 is a schematic diagram of an electronic device with positioning function according to another embodiment of the invention.

### DETAILED DESCRIPTION

In the specification and claims which uses some words to refer to particular components. Skill in the art will appreciate, manufacturers may use different terms to refer to a component. This specification and the claims are not to differences in the names as a way to distinguish elements, but with differences in the functional element as case quasi Tony U. Mentioned throughout the specification and claims in terms of “comprising” as an open-ended term, it should be interpreted as “including but not limited to.” In addition, “coupled” as used in this contain any direct and indirect electrical connection means. Therefore, if the text describing the first device is coupled to the second device, the first device may represent a direct electrical connection to the second device, or connected to the second means through other means or indirectly electrically connecting means.

The following description to achieve a preferred embodiment of the present invention, which is to describe the principles of the object of the present invention, is not to limit the present invention. It can be appreciated that the embodiment of the invention is achieved by software, hardware, firmware, or any combination thereof.

A detailed description is given in the following embodiments with reference to the accompanying drawings.

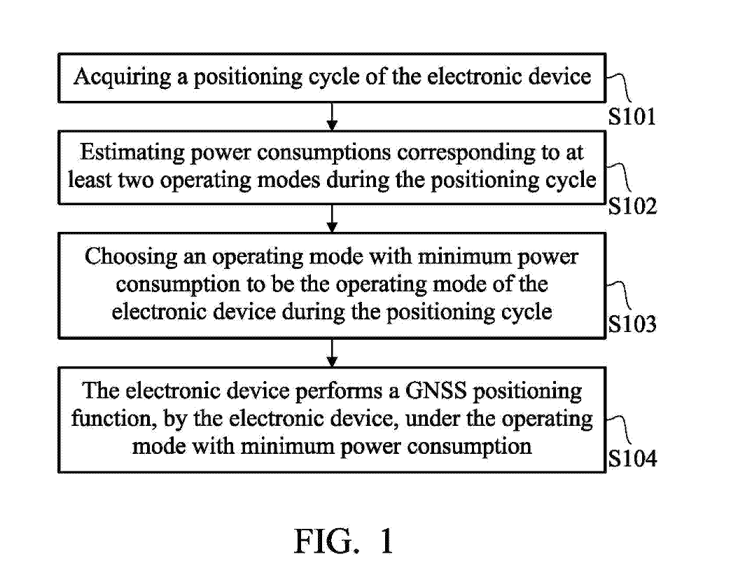

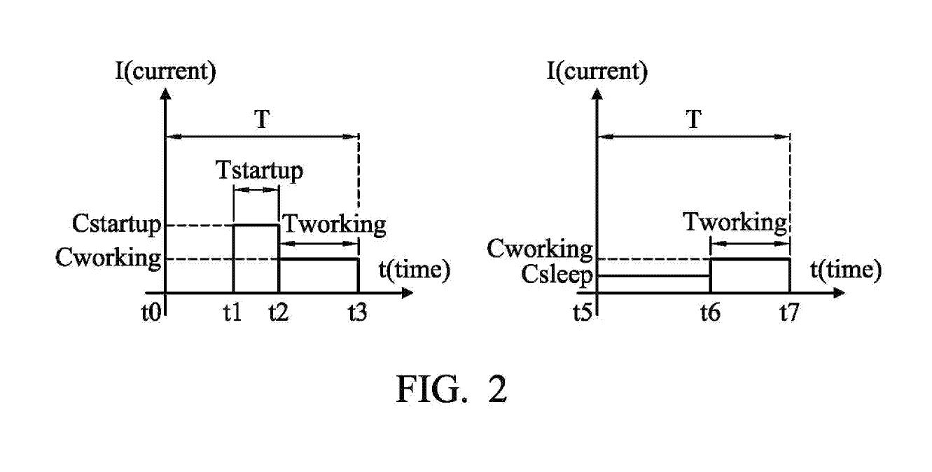

As shown in FIG. 1 and FIG. 2. FIG. 1 is flowchart of a power-saving method for an electronic device according to an embodiment of the invention, wherein the electronic device has positioning function. The power-saving method comprises steps listed as following.

Step S101: acquiring a positioning cycle of the electronic device.

It is understood that the electronic device acquires a next positioning cycle T after a current position procedure in step S101, and steps are repeated to implement periodic work of the electronic device. It is noted that the positioning cycle T may be not a constant value. It changes according to the changing of various parameters in general situations. The periodic feature in this embodiment means that the electronic device can predict a next operation time after a current operation. In other words, the periodic feature means parameters of the electronic device are predictable. The positioning cycle T is determined according the satellite signal strength, satellite ephemeris received, positioning accuracy, or other status.

Step S102: estimating power consumptions corresponding to at least two operating modes during the positioning cycle.

In this embodiment, the at least two operating modes comprise a first operating mode and a second operating mode, the first operating mode is a turn-off operating mode, and the second operating mode is a sleeping operating mode. It should be understood that the first operating mode is not limited to the turn-off operating mode, and the second operating mode is not limited to the sleeping operating mode. The first operating mode and the second operating mode may also be based on the actual circumstances.

As shown in FIG. 2, a positioning cycle T of the turn-off operating mode comprises an activation time Tstartup (t1 to t2) and a normal operation time Tworking(t2 to t3). The activation time Tstartup is an activation time that the electronic device switches from the turn-off state to the turn-in state. The normal operation time Tworking is the normal operation time for performing a Global Navigation Satellite System positioning function. It should be understood that the positioning cycle T further comprises a turn-off time (t0 to t1), and no current is consumed by the electronic device during the turn-off time. After the electronic device completes a current task, if the electronic device is turned off, a current variation versus time of a procedure that the electronic device is turned off, activated and acquires data is shown as a left part of FIG. 2. A first power consumption W1 corresponding to the turn-off operating mode during the positioning cycle is estimated by equation:

W1=Cstartup×Tstartup+Cworking×Tworking,

wherein Cstartup is an average current that the electronic device switches from a turn-off state to a turn-in state, and Cworking is an average current when the electronic device operates during the normal operation time. It is noted that Cstartup, Tstartup, Cworking and Tworking can be provided by the electronic device. In other words, the customer can define Cstartup, Tstartup, Cworking and Tworking, and the positioning cycle T may be affected to be varied by various parameters.

With further reference to FIG. 2, the positioning cycle of the sleeping operating mode comprises a sleeping time (T−Tworking) and the normal operation time (Tworking), wherein a small current is provided to maintain a basic function of the electronic device during the sleeping operating mode. After the electronic device completes a current task, if the electronic device is at the sleeping mode, a current variation versus time of a procedure that the electronic device is at the sleeping mode, activated and acquires data is shown as a right part of FIG. 2. A second power consumption W2 corresponding to the sleeping operating mode during the positioning cycle is estimated by equation:

W2=Csleep×(T−Tworking)+Cworking×Tworking,

wherein Csleep is an average current that the electronic device has in a sleeping state, Cworking is an average current when the electronic device operates during the normal operation time, and Tworking is the normal operation time. It is noted that Csleep and Tworking can be provided by the electronic device. In other words, the customer can define Csleep and Tworking, and the positioning cycle T may be affected to be varied by various parameters. Furthermore, the Tworking and Cworking shown in both left part and right part of FIG. 2 can be the same.

It should be understood that the at least two operating modes further comprise a third operating mode. In step S102, the first power consumption of the electronic device corresponding to the turn-off operating mode during the positioning cycle, the second power consumption of the electronic device corresponding to the sleeping operating mode during the positioning cycle and a third power consumption of the electronic device corresponding to the third operating mode during the positioning cycle are estimated respectively. The third power consumption W3 is estimated by equation:

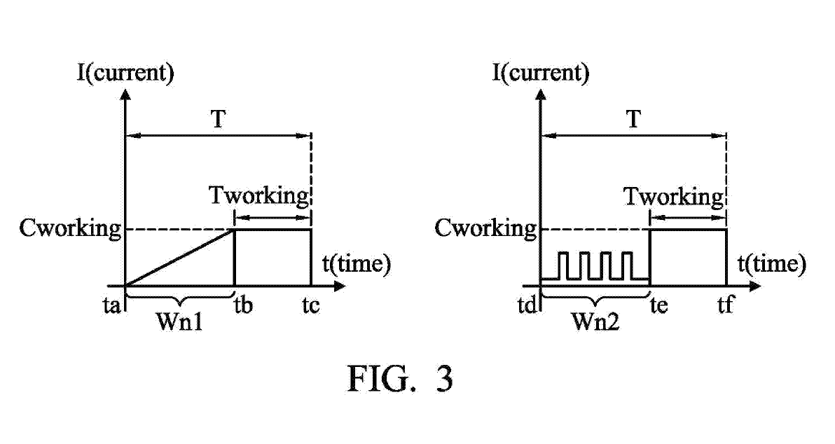

W3=Wn+Cworking×Tworking,

wherein W3 is the third power consumption of the electronic device corresponding to the third operating mode during the positioning cycle, Wn is a power consumption of the electronic device during the non-working time, Cworking is an average current when the electronic device operates during the normal operation time, and Tworking is the normal operation time. The third operating mode may be a progressive operating mode (shown in left part of FIG. 3) or a monitoring operating mode (shown in right part of FIG. 3). A current of the electronic device during a non-operation period (time ta-tb) of the progressive operating mode, gradually increases, and the electronic device is entering to a normal operating mode. The electronic device monitors whether a special message is received during a non-operation period (time td to time te) of the monitoring operating mode. It is understood that the third operating mode is not limited to the progressive operating mode or the monitoring operating mode. The third operating mode can be other operating mode based on actual situation.

Step S103: choosing an operating mode with minimum power consumption from the at least two operating modes to be the operating mode of the electronic device during the positioning cycle.

Without considering the same power consumption (CworkingxTworking) of the first power consumption and the second power consumption, two remaining power consumption values are estimated:

W1′=Cstartup×Tstartup,

W2′=Csleep×(T−Tworking).

According to the two power differences, which power consumption is smaller can be determined to achieve an object of low power consumption control mechanism. Specifically, when W1′ is smaller than W2′, the first power consumption W1 corresponding to the turn-off operating mode is smaller than the second power consumption W2 corresponding to the sleeping operating mode, and the turn-off operating mode is selected to be the operating mode during the positioning cycle. When W1′ is larger than W2′, the first power consumption W1 corresponding to the turn-off operating mode is larger than the second power consumption W2 corresponding to the sleeping operating mode, and the sleeping operating mode is selected to be the operating mode during the positioning cycle.

When the operating modes are more than two, power difference values among power consumptions, such as W1′, W2′, Wn1 and/or Wn2, are estimated to determine which operating mode, such as turn-off operating mode, sleeping operating mode or the third operating mode, is adopted to achieve the object of low power consumption control. If Wn1 is smaller than W1′, W2′ and Wn2, the progressive operating mode is adopted to be the operating mode of the electronic device during the positioning cycle. If Wn2 is smaller than W1′, W2′ and Wn1, the monitoring operating mode is adopted to be the operating mode of the electronic device during the positioning cycle. It is understood that the invention is not limited to the illustrated operating modes. The invention can be applied and covered to other operating mode, which can be selected by a power consumption of non-working duration estimated during the positioning cycle.

Step S104: The electronic device performs a Global Navigation Satellite System positioning function, under the operating mode with minimum power consumption.

It should be understood that the positioning cycle of each operating mode comprises a non-work duration and a working duration. The non-work duration may be a sleeping duration, a turn-off duration or other duration. In this embodiment, the electronic device with positioning function is turned off, turned on or enters a sleeping mode, but not limit the invention thereto. Only part of circuits or modules is turned off, turned on or enters the sleeping mode in other embodiment. Note that part of circuits or modules is integrated with the electronic device with positioning function.

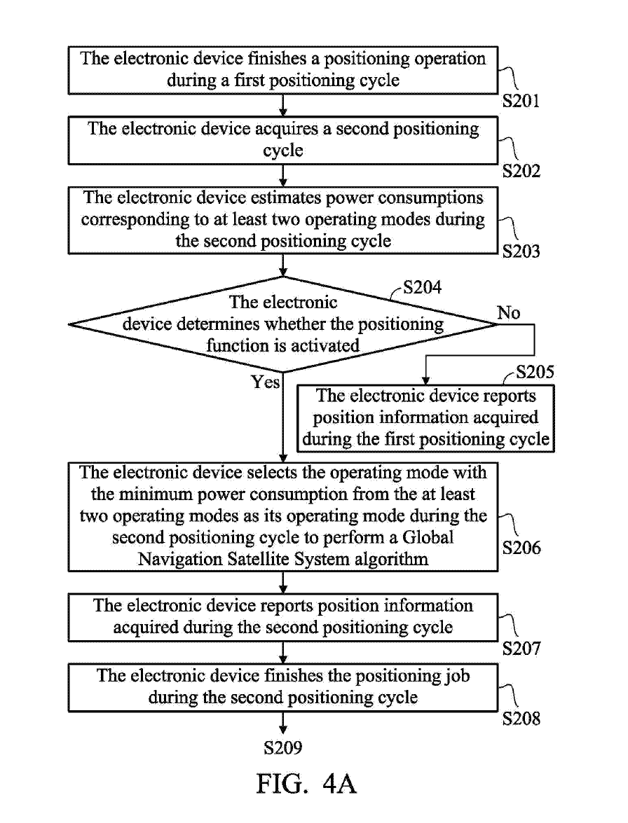

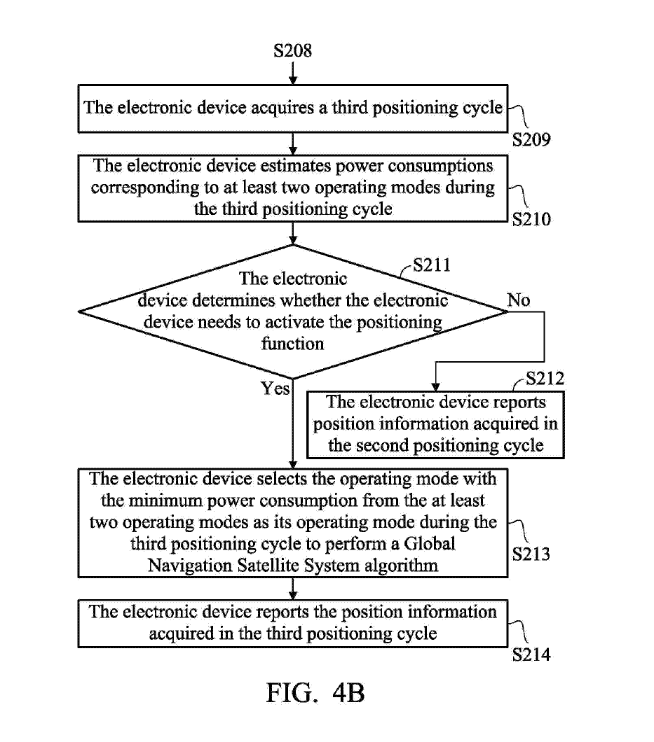

FIGS. 4A and 4B show a flowchart of a power-saving method for an electronic device with positioning function according to another embodiment of the invention. The method comprises steps listed in the following.

Step S201: The electronic device finishes a positioning operation during a first positioning cycle.

Step S202: The electronic device acquires a second positioning cycle Ta.

Step S203: The electronic device estimates power consumptions corresponding to at least two operating modes during the second positioning cycle Ta.

Step S204: The electronic device determines whether the positioning function is activated.

In step S204, the electronic device determines whether the positioning function is activated by monitoring information of a base station and determining whether the information is changed. If the information of the base station does not change, it means that the base station wireless connected to the electronic device is the same as the base station connected by the electronic device during the first positioning cycle. If the information changes, it means that base station wireless connected to the electronic device is different from the base station connected by the electronic device during the first positioning cycle. The positioning function needs to be activated to locate the position of the electronic device. It is understood that the invention uses the information of base station to determine whether the positioning function needs to be activated, but not limit the invention thereto. The invention can use sensors embedded in the electronic device, WiFi signal or signal strength of WiFi signal to determine whether positioning function needs to be activated. For example, an embodiment of the invention determines whether the electronic device is still connected to the same WiFi source to determine whether the positioning function needs to be activated. In another embodiment, an embodiment of the invention determines whether the signal strength of WiFi signal is still larger than a threshold value, and if yes, it means that the electronic device is substantially at the same place and there is no need to activate the positioning function. It should be understood that the determination mechanism can be customized and be modified based on actual situations.

If the positioning function does not need to be activated, step S205 is executed, and the electronic device reports position information acquired during the first positioning cycle.

If the positioning function needs to be activated, step S206 is executed, i.e. the electronic device selects the operating mode with the minimum power consumption from the at least two operating modes as its operating mode during the second positioning cycle Ta to perform a Global Navigation Satellite System algorithm. For example, if the operating mode with the minimum power consumption is a first operating mode, the electronic device selects the first operating mode as its operating mode during the second positioning cycle Ta to perform a Global Navigation Satellite System algorithm.

In the embodiment, it is assumed that the first operating mode is selected, which is a turn-off operating mode. The electronic device turns off GNSS (Global Navigation Satellite System) at time t0, and turns on GNSS at time t2 to perform a positioning algorithm, wherein the activation time is between the time t0 and the time t2. It should be understood that when other functions of the electronic device does not operate, the electronic device enters the turn-off operating mode at time t3. It is noted that the electronic device is not limited to select the first operating mode to perform a GNSS positioning algorithm in the second positioning cycle Ta. The electronic device selects an operating mode with the minimum power consumption to perform the GNSS positioning algorithm.

Step S207: The electronic device reports position information acquired during the second positioning cycle Ta.

Step S208: The electronic device finishes the positioning job during the second positioning cycle.

Step S209: The electronic device acquires a third positioning cycle Tb.

It should be explained that the second positioning cycle Ta and the third positioning cycle Tb may be the same or different due to effect from various parameters.

In this embodiment, the normal operation time of the second positioning cycle Ta is the same as the normal operation time of the third positioning cycle Tb.

Step S210: The electronic device estimates power consumptions corresponding to at least two operating modes during the third positioning cycle.

Step S211: The electronic device determines whether the electronic device needs to activate the positioning function. Note that step S211 is similar to step S204, and not described here for briefly.

If the electronic device does not need to activate the positioning function, step S212 is executed. It means that the position of the electronic device may not change or the position change can be ignored. In step S212, the electronic device reports position information acquired in the second positioning cycle Ta.

If the electronic device activates the positioning function, it means the electronic device has moved out a predetermined range and step S213 is executed, i.e. the electronic device selects the operating mode with the minimum power consumption from the at least two operating modes as its operating mode during the third positioning cycle Tb to perform a Global Navigation Satellite System algorithm. For example, if the operating mode with the minimum power consumption is a second operating mode, the electronic device selects the second operating mode as its operating mode during the third positioning cycle Tb to perform a Global Navigation Satellite System algorithm.

In step S213, the second operating mode is a sleeping operating mode. The electronic device turns off GNSS (Global Navigation Satellite System) at time t3, and uses GNSS at time t6 to perform a positioning algorithm. It should be understood that when other functions of the electronic device does not operate, the electronic device enters the sleeping operating mode at time t5. It is noted that the electronic device is not limited to select the second operating mode to perform a GNSS positioning algorithm in the third positioning cycle Tb. The electronic device selects an operating mode with the minimum power consumption to perform the GNSS positioning algorithm.

Step S214: The electronic device reports the position information acquired in the third positioning cycle Tb.

It should be understood that the electronic device can execute positioning task during a fourth positioning cycle, a fifth positioning cycle or other positioning cycle after finishing the positioning task during the third positioning cycle. The operation of the following positioning cycle is similar to operation of previous positioning cycle and not discussed here for briefly. Note that the steps in FIG. 4A and FIG. 4B can change the order to be executed based on the actual situations.

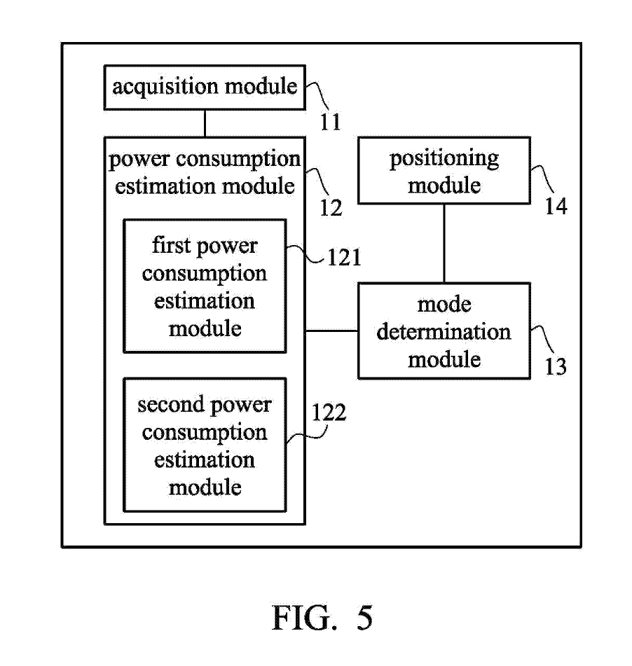

FIG. 5 is a schematic diagram of an electronic device with positioning function according to an embodiment of the invention. The electronic device shown in FIG. 5 corresponds to electronic device shown in FIG. 1. The electronic device comprises a cycle acquisition module 11, a power consumption estimation module 12, a mode determination module 13 and a positioning module 14.

The cycle acquisition module 11 acquires a positioning cycle of the electronic device.

The power consumption estimation module 12 estimates power consumptions corresponding to at least two operating modes during the positioning cycle, wherein the at least two operating mode comprises a first operating mode and a second operating mode, the first operating mode is a turn-off operating mode, the second operating mode is a sleeping operating mode, the positioning cycle of the turn-off operating mode comprises an activation time and a normal operation time, and the positioning cycle of the sleeping operating mode comprises a sleeping time and the normal operation time. Specifically, the power consumption estimation module 12 estimates first power consumption corresponding to the turn-off operating mode during the positioning cycle, and a second power consumption corresponding to the sleeping operating mode during the positioning cycle.

In this embodiment, the power consumption estimation module 12 further comprises a first power consumption estimation module 121 and a second power consumption estimation module 122. The first power consumption estimation module 121 estimates a first power consumption of the electronic device corresponding to the turn-off operating mode during the positioning cycle by equation:

W1=Cstartup×Tstartup+Cworking×Tworking,

wherein Cstartup is an average current that the electronic device switches from a turn-off state to an turn-in state, and Cworking is an average current when the electronic device operates during the normal operation time.

The second power consumption estimation module 122 estimates a second power consumption W2 corresponding to the sleeping operating mode during the positioning cycle is estimated by equation:

W2=Csleep×(T−Tworking)+Cworking×Tworking,

wherein Csleep is an average current that the electronic device has in a sleeping state, Cworking is an average current when the electronic device operates during the normal operation time, and Tworking is the normal operation time.

The mode determination module 13 chooses an operating mode with minimum power consumption from the at least two operating mode to be the operating mode of the electronic device during the positioning cycle.

In this embodiment, the mode determination module 13 chooses the turn-off operating mode or the sleeping operating mode to be the operating mode during the positioning cycle by power difference W1′ and W2′ as following:

W1′=Cstartup×Tstartup,

W2′=Csleep×(T−Tworking).

When W1′ is smaller than W2′, the first power consumption W1 corresponding to the turn-off operating mode is smaller than the second power consumption W2 corresponding to the sleeping operating mode, and the turn-off operating mode is selected to be the operating mode during the positioning cycle. When W1′ is larger than W2′, the first power consumption W1 corresponding to the turn-off operating mode is larger than the second power consumption W2 corresponding to the sleeping operating mode, and the sleeping operating mode is selected to be the operating mode during the positioning cycle.

It should be noted that the electronic device further comprises a positioning determination module (not shown) to determine whether the electronic device needs to activate the positioning function. The positioning determination module determines whether the positioning function is activated by monitoring information of base station and determining whether the information is changed. If the information does not change, it means that the base station wireless connected to the electronic device is the same as the base station connected by the electronic device during the first positioning cycle. If the information changes, it means that base station wireless connected to the electronic device is different from the base station connected by the electronic device during the first positioning cycle. The positioning function needs to be activated to locate the position of the electronic device. It is understood that the invention uses the information of base station to determine whether the positioning function needs to be activated, but not limit the invention thereto. The invention can use sensors embedded in the electronic device, WiFi signal or signal strength of WiFi signal to determine whether positioning function needs to be activated. For example, an embodiment of the invention determines whether the electronic device is still connected to the same WiFi source to determine whether the positioning function needs to be activated. In another embodiment, an embodiment of the invention determines whether the signal strength of WiFi signal is still larger than a threshold value, and if yes, it means that the electronic device is substantially at the place and there is no need to activate the positioning function. It should be understood that the determination mechanism can be customized and be modified based on actual situations.

The positioning module 14 to perform a Global Navigation Satellite System positioning function under the operating mode with minimum power consumption.

Alternatively, the positioning module 14 to perform a Global Navigation Satellite System positioning function under the operating mode with minimum power consumption when the positioning determination module determines that the electronic device needs to activate the positioning function.

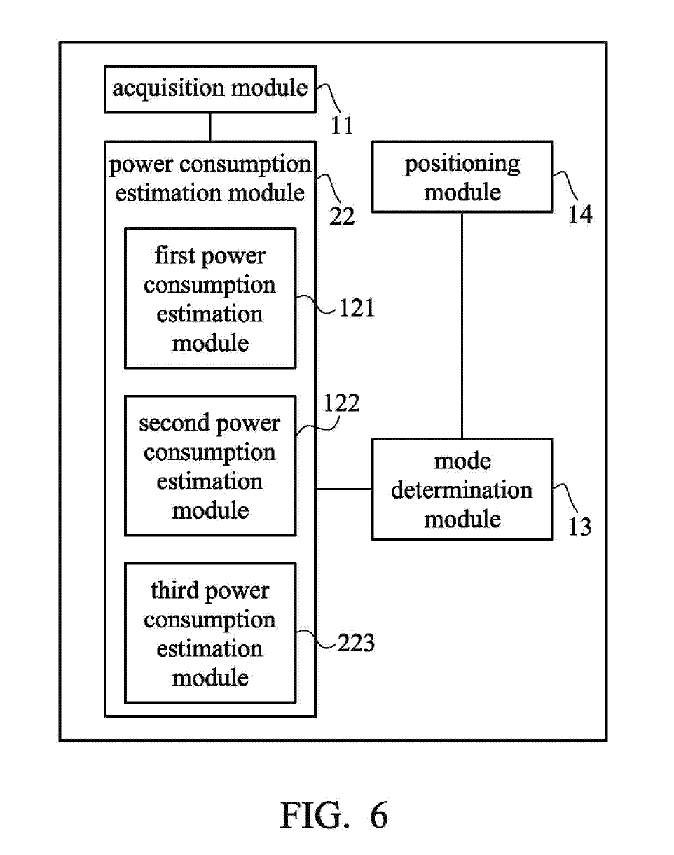

Furthermore, please refer to FIG. 6. FIG. 6 is a schematic diagram of an electronic device with positioning function according to another embodiment of the invention. The difference between the electronic devices shown in FIG. 5 and FIG. 6 is described in following.

The at least two operating modes further comprises a third operating mode. The third operating mode may be a progressive operating mode (shown in left part of FIG. 3) or a monitoring operating mode (shown in right part of FIG. 3). A current of the electronic device during a non-operation period (time ta-tb) of the progressive operating mode, gradually increases, and the electronic device is entering to a normal operating mode. The electronic device monitors whether a special message is received during a non-operation period (time td to time te) of the monitoring operating mode. It is understood that the third operating mode is not limited to the progressive operating mode or the monitoring operating mode. The third operating mode can be other operating mode based on actual situation.

The power consumption estimation module 22 estimates first power consumption corresponding to the turn-off operating mode during the positioning cycle, a second power consumption corresponding to the sleeping operating mode during the positioning cycle, and a third power consumption of the electronic device corresponding to the third operating mode during the positioning cycle.

The power consumption estimation module 22 further comprises a third power consumption estimation module 223 to estimate the third power consumption of the electronic device corresponding to the third operating mode during the positioning cycle by equation:

W3=Wn+Cworking×Tworking,

wherein Wn is a power consumption of the electronic device during the non-working time, Cworking is an average current when the electronic device operates during the normal operation time, and Tworking is the normal operation time.

The mode determination module 13 selects the turn-off operating mode, the sleeping operating mode or the third operating mode to be the operating mode during the positioning cycle according to power difference values among power consumptions, such as W1′, W2′, Wn1 and/or Wn2, to achieve the object of low power consumption control. If Wn1 is smaller than W1′, W2′ and Wn2, the progressive operating mode is adopted to be the operating mode of the electronic device during the positioning cycle. If Wn2 is smaller than W1′, W2′ and Wn1, the monitoring operating mode is adopted to be the operating mode of the electronic device during the positioning cycle.

An embodiment of the invention provides electronic devices with low-consumption and the electronic devices are able to maintain periodicity GNSS positioning accuracy. The electronic devices may be portable devices or wearable devices. The portable devices or wearable devices can select an operating mode with minimum power consumption to be the operating mode during a positioning cycle according to usage scenario of the electronic devices.

In summary, the invention first estimates power consumptions corresponding to at least two operating modes during the positioning cycle, and then chooses an operating mode with minimum power consumption to be the operating mode of the electronic device during the positioning cycle. It can greatly reduce the power consumption of the electronic device during the positioning cycle and increases battery life of the electronic device.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A power saving method for an electronic device with positioning function, comprising:
acquiring a positioning cycle of the electronic device;
estimating power consumptions corresponding to at least two operating modes during the positioning cycle; and
choosing an operating mode with minimum power consumption from the at least two operating modes to be the operating mode of the electronic device during the positioning cycle.

2. The method as claimed in claim 1, further comprising:
performing a Global Navigation Satellite System positioning function, by the electronic device, under the operating mode with minimum power consumption.

3. The method as claimed in claim 1, further comprising:
determining whether the electronic device needs to activate the positioning function.

4. The method as claimed in claim 1, wherein the at least two operating mode comprises a first operating mode and a second operating mode, the first operating mode is a turn-off operating mode, the second operating mode is a sleeping operating mode, the positioning cycle of the turn-off operating mode comprises an activation time and a normal operation time, and the positioning cycle of the sleeping operating mode comprises a sleeping time and the normal operation time.

5. The method as claimed in claim 4, wherein the power consumptions corresponding to at least two operating modes are estimated according to equations listed as following:
W1=Cstartup×Tstartup+Cworking×Tworking,
wherein W1 is a first power consumption of the electronic device corresponding to the turn-off operating mode during the positioning cycle, Cstartup is an average current that the electronic device switches from a turn-off state to a turn-in state, Tstartup is the activation time that the electronic device switches from the turn-off state to the turn-in state, Cworking is an average current when the electronic device operates during the normal operation time, and Tworking is the normal operation time; and
W2=Csleep×(T−Tworking)+Cworking×Tworking, wherein
W2 is a second power consumption of the electronic device corresponding to the sleeping operating mode during the positioning cycle, Csleep is an average current that the electronic device has in a sleeping state, Cworking is an average current when the electronic device operates during the normal operation time, and Tworking is the normal operation time.

6. The method as claimed in claim 5, wherein the at least two operating modes further comprises a third operating mode;
the step of estimating power consumptions corresponding to the at least two operating modes during the positioning cycle further comprises:
estimating the first power consumption of the electronic device corresponding to the turn-off operating mode during the positioning cycle, the second power consumption of the electronic device corresponding to the sleeping operating mode during the positioning cycle, and a third power consumption of the electronic device corresponding to the third operating mode during the positioning cycle.

7. The method as claimed in claim 6, wherein the positioning cycle of the third operating mode comprises a non-working time and the normal operation time, the third power consumption corresponding to the third operating mode is estimated by the equation as following:
W3=Wn+Cworking×Tworking,
wherein W3 is the third power consumption of the electronic device corresponding to the third operating mode during the positioning cycle, Wn is a power consumption of the electronic device during the non-working time, Cworking is an average current when the electronic device operates during the normal operation time, and Tworking is the normal operation time.

8. The method as claimed in claim 6, wherein the third operating mode is a progressive operating mode or a monitoring operating mode.

9. An electronic device with positioning function, comprising:
a cycle acquisition module, arranged to acquire a positioning cycle of the electronic device;
a power consumption estimation module, arranged to estimate power consumptions corresponding to at least two operating modes during the positioning cycle; and
a mode determination module, arranged to choose an operating mode with minimum power consumption from the at least two operating modes to be the operating mode of the electronic device during the positioning cycle.

10. The electronic device with positioning function as claimed in claim 9, further comprising:
a positioning module, arranged to perform a Global Navigation Satellite System positioning function, under the operating mode with minimum power consumption.

11. The electronic device with positioning function as claimed in claim 9, further comprising:
a positioning determination module, arranged to determine whether the electronic device needs to activate the positioning function.

12. The electronic device with positioning function as claimed in claim 9, wherein the at least two operating mode comprises a first operating mode and a second operating mode, the first operating mode is a turn-off operating mode, the second operating mode is a sleeping operating mode, the positioning cycle of the turn-off operating mode comprises an activation time and a normal operation time, and the positioning cycle of the sleeping operating mode comprises a sleeping time and the normal operation time.

13. The electronic device with positioning function as claimed in claim 9, wherein the power consumption estimation module further comprises a first power consumption estimation module and a second power consumption estimation module to estimate a first power consumption of the electronic device corresponding to the turn-off operating mode during the positioning cycle and a second power consumption of the electronic device corresponding to the sleeping operating mode during the positioning cycle respectively, the first power consumption is estimated by equation:
W1=Cstartup×Tstartup+Cworking×Tworking,
wherein W1 is the first power consumption of the electronic device corresponding to the turn-off operating mode during the positioning cycle, Cstartup is an average current that the electronic device switches from a turn-off state to a turn-in state, Tstartup is the activation time that the electronic device switches from the turn-off state to the turn-in state, Cworking is an average current when the electronic device operates during the normal operation time, and Tworking is the normal operation time; and
the second power consumption is estimated by equation:
W2=Csleep×(T−Tworking)+Cworking×Tworking, wherein
W2 is the second power consumption of the electronic device corresponding to the sleeping operating mode during the positioning cycle, Csleep is an average current that the electronic device has in a sleeping state, Cworking is an average current when the electronic device operates during the normal operation time, and Tworking is the normal operation time.

14. The electronic device with positioning function as claimed in claim 13, wherein the at least two operating modes further comprises a third operating mode, and the power consumption estimation module estimate the first power consumption of the electronic device corresponding to the turn-off operating mode during the positioning cycle, the second power consumption of the electronic device corresponding to the sleeping operating mode during the positioning cycle respectively and a third power consumption of the electronic device corresponding to the third operating mode during the positioning cycle.

15. The electronic device with positioning function as claimed in claim 14, wherein the power consumption estimation module further comprises:
a third power consumption estimation module, arranged to estimate the third power consumption of the electronic device corresponding to the third operating mode during the positioning cycle, the third power consumption is estimated by equation:
W3=Wn+Cworking×Tworking,
wherein W3 is the third power consumption of the electronic device corresponding to the third operating mode during the positioning cycle, Wn is a power consumption of the electronic device during the non-working time, Cworking is an average current when the electronic device operates during the normal operation time, and Tworking is the normal operation time.

16. The electronic device with positioning function as claimed in claim 14, wherein the third operating mode is a progressive operating mode or a monitoring operating mode.
